(19) United States
(12) Patent Application Publication
(10) Pub. No.: US 2026/0162907 A1
(43) Pub. Date: Jun. 11, 2026

(54) ALUMINUM ETCHING FOIL FOR ELECTROLYTIC CAPACITOR

(71) Applicant: Panasonic Intellectual Property Management Co., Ltd., Osaka (JP)

(72) Inventors: Mitsuhisa YOSHIMURA, OSAKA FU (JP); Toshifumi KADOKAWA, HYOGO KEN (JP); Masami TSUBAKI, KYOTO FU (JP); Kyohei KOBAYASHI, KYOTO FU (JP); Hiroshi YOSHIDA, KYOTO FU (JP)

(21) Appl. No.: 19/183,421

(22) Filed: Apr. 18, 2025

Related U.S. Application Data
(63) Continuation of application No. PCT/JP2023/038506, filed on Oct. 25, 2023.

(30) Foreign Application Priority Data
Oct. 28, 2022 (JP) 2022-173592

(51) Int. Cl. H01G 9/055; H01G 9/00; H01G 9/045

(52) U.S. Cl. CPC H01G 9/055; H01G 9/0029; H01G 9/045

(57) ABSTRACT

An aluminum etching foil for an electrolytic capacitor disclosed herein has a width in a range of 460 to 520 mm and a length of 100 m or more, and includes a core portion and two porous portions continuous with the core portion and constituting first and second main surfaces. The porous portions are porous portions formed by etching. When E1 (mg/cm²) is the smaller of etching amounts per unit area in two end regions extending to a distance in a range of 2 to 7 mm away from two ends in a width direction at a desired position, and E2 (mg/cm²) is an average etching amount per unit area in a central region inward of the two end regions, a ratio E1/E2 is 0.90 or more and 1.30 or less.

### CROSS REFERENCE TO RELATED APPLICATION

The present application is a continuation application of International Application No. PCT/JP2023/038506, filed on Oct. 25, 2023, which claims the priority benefit of Japanese Patent Application No. 2022-173592, filed on Oct. 28, 2022 in the Japan Patent Office, and the entire contents of each of which are hereby incorporated by reference.

### TECHNICAL FIELD

The present disclosure relates to an aluminum etching foil for an electrolytic capacitor.

### BACKGROUND ART

An electrode foil for the electrolytic capacitor is usually formed by cutting a large piece of metal foil. Various proposals have been made so far regarding a metal foil for the electrolytic capacitor.

Claim 1 of Japanese Laid-Open Patent Publication No. 2008-159922 discloses “a method for manufacturing an electrode foil for an electrolytic capacitor in which an aluminum foil is etched by being passed between a pair of electrode plates in an electrolyte, the method including: providing an electrical shielding plate having a plurality of slit-like openings between the aluminum foil and an opposing electrode plate and performing etching while controlling a current flowing between the electrodes and the aluminum foil, wherein the slit-like openings of the electrical shielding plate each have a V-shape extending from a point at a center in a width direction of the aluminum foil toward ends of the aluminum foil and upward in an etching tank”.

### SUMMARY

Aluminum etching foil for an electrolytic capacitor is traded on the market in forms having a width of about 500 mm and a length of 100 to 2000 m. Since the aluminum etching foil is produced by electrolytic etching, there are areas at two ends of the foil in the width direction where the etching amount is less than that at the center of the foil in the width direction. If the etching amount varies in the width direction of the foil, the thickness of an oxide film produced in subsequent chemical conversion treatment is likely to vary in the width direction. As a result, bending and wrinkles are likely to occur at the two ends of the foil. The bending and wrinkles cause undesirable foil breakage during steps such as chemical conversion treatment, slit processing, and winding.

Further, when the thickness, the etching amount, and the capacitance of an etched layer vary in the width direction, tension during foil transport, stress generated by transport rollers, and pressure applied when pressing the foil will cause a difference in elongation of the foil, resulting in wrinkles and cracks in the foil and cracks in the etched layer.

In response to recent demand for higher capacity, the etching amount has been increased (that is, the etched layer has been deepened) to improve capacitance. However, this has resulted in more problems with wrinkles and strength in the etching foil. The impact of this problem is particularly significant in a hybrid capacitor having a narrow foil width and often used at high voltages, and the like.

In this situation, one object of the present disclosure is to provide an aluminum etching foil that enables stable production of a high-capacity electrolytic capacitor at low cost, and a method for manufacturing the aluminum etching foil.

One aspect of the present disclosure relates to an aluminum etching foil for an electrolytic capacitor. The etching foil has a width in a range of 460 to 520 mm and a length of 100 m or more, and includes a core portion and two porous portions continuous with the core portion and constituting first and second main surfaces, wherein the porous portions are porous portions formed by etching, and when E1 (mg/cm²) is a smaller of etching amounts per unit area in two end regions extending to a distance in a range of 2 to 7 mm away from two ends in a width direction at a desired position, and E2 (mg/cm²) is an average etching amount per unit area in a central region inward of the two end regions, a ratio E1/E2 is 0.90 or more and 1.30 or less.

Another aspect of the present disclosure relates to another aluminum etching foil for an electrolytic capacitor. The other aluminum etching foil has a width in a range of 460 to 520 mm and a length of 100 m or more, and includes a core portion and two porous portions continuous with the core portion and constituting first and second main surfaces, wherein when T1 (μm) is a sum of thicknesses of the two porous portions at a position 2 mm away from one end in a width direction at a desired position, and T2 (μm) is a sum of thicknesses of the two porous portions at a central position in the width direction at the desired position. 0.1≤T1/T2 is satisfied.

The present disclosure provides an aluminum etching foil that enables the stable production of a high-capacity electrolytic capacitor at low cost.

Novel features of the present invention are set forth in the appended claims, but the present invention, both as to configuration and content, together with other objects and features of the present invention, will be better understood from the following detailed description taken in conjunction with the drawings.

### BRIEF DESCRIPTION OF DRAWINGS

FIG. 1 is a diagram schematically illustrating one step of an example of a method for manufacturing an aluminum etching foil according to the present disclosure.

FIG. 2A is a top view schematically illustrating a structure of the aluminum etching foil manufactured in the process illustrated in FIG. 1.

FIG. 2B is a top view schematically illustrating a structure of an example of the aluminum etching foil according to the present disclosure.

FIG. 3 is a sectional view schematically illustrating a structure of an example of the aluminum etching foil according to the present disclosure.

FIG. 4 is a schematic diagram for explaining a method for measuring an etching amount.

### DETAILED DESCRIPTION

Hereinafter, embodiments according to the present disclosure are described using examples, but the present disclosure is not limited to the examples described below. In the following description, specific numerical values and materials may be given as examples, but other numerical values and materials may be applied as long as effects of the present disclosure are obtained. In this specification, the expression “numerical value A to numerical value B” includes the numerical value A and the numerical value B, and can be read as “numerical value A or more and numerical value B or less”. When a plurality of materials are given as examples, unless otherwise specified, one may be selected from the multiple exemplified materials and used alone, or two or more may be used in combination.

### (Aluminum Etching Foil for Electrolytic Capacitor)

Hereinafter, first and second aluminum etching foils are described as aluminum etching foils for an electrolytic capacitor. The first aluminum etching foil and the second aluminum etching foil may be respectively referred to as “foil (F1)” and “foil (F2)” below. The foil (F1) and the foil (F2) may be collectively referred to as “foil (F)”. Matters described regarding the foil (F) can be applied to both the foil (F1) and the foil (F2).

For an aluminum raw foil (a first sheet described later) that is a material for the foil (F), an aluminum foil having a purity of 99.5 mass % or more is usually used, and it is preferable to use an aluminum foil having a purity of 99.90 mass % or more (for example, 99.95 mass % or more). The aluminum raw foil may contain trace amounts of other elements as long as it is possible to manufacture the aluminum etching foil for an electrolytic capacitor. The other elements are not particularly limited. Examples of the other elements include metal elements such as Cu, Fe, and Si.

The foil (F) can be used as a material for an electrode foil for an electrolytic capacitor. The foil (F) may be used as a material for an anode foil or may be used as a material for a cathode foil. The foil (F) is cut to the size of the anode foil or the cathode foil and used as the electrode foil for an electrolytic capacitor. Note that a predetermined step may be performed before and/or after cutting. For example, when the foil (F) is used as an anode foil, a chemical conversion treatment may be performed before and/or after cutting.

### (First Aluminum Etching Foil)

The first aluminum etching foil (foil (F1)) has a width W in a range of 460 to 520 mm and a length L of 100 m or more. The foil (F1) includes a core portion and two porous portions continuous with the core portion and constituting first and second main surfaces. The porous portions are porous portions formed by etching. When E1 (mg/cm²) is the smaller of etching amounts per unit area in two end regions extending to a distance of 2 to 7 mm away from two ends in a width direction at a desired position, and E2 (mg/cm²) is the average etching amount per unit area in a central region (an inner region) inward of the two end regions, a ratio E1/E2 is 0.90 or more and 1.30 or less.

In the foil (F1), the difference between the etching amount in the central region and the etching amounts in the end regions in the width direction is small. Therefore, bending and wrinkles at the two ends of the foil (F1) can be suppressed. Furthermore, when the foil (F1) is processed to prepare the electrode foil for an electrolytic capacitor, cracking of the foil and the etched layer can be suppressed. Therefore, by using the foil (F1), it is possible to stably manufacture a high-capacity electrolytic capacitor at low cost.

The etching amount per unit area means the etching amount per 1 cm² of the foil (F1). Specifically, it is expressed as a sum of the etching amounts of the two porous portions on both sides of the core portion of 1 cm² foil. Details of a method for measuring the etching amount will be described in the examples. The two end regions and the central region are selected from among regions present in the width direction at a selected desired position on the foil (F1).

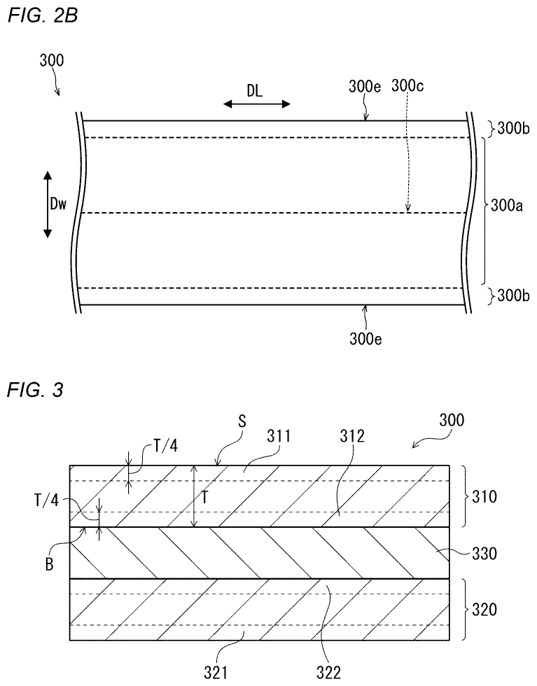

The etching amount per unit area in the end regions is measured by the following procedure. First, a 10 cm long sample extending to a distance of 2 to 7 mm from one end in the width direction at a desired position is cut out. In this way, a sample having a width of 0.5 cm (width in a width direction Dw in FIG. 2A) and a length of 10 cm (length in a longitudinal direction DL in FIG. 2A) is obtained. Subsequently, the etching amount of the obtained sample is measured and divided by the area of the sample (5 cm²) to determine the etching amount per unit area. The etching amount per unit area in the end region at the other end in the width direction is also determined in the same manner. Then, the smaller of the two obtained etching amounts per unit area is defined as the etching amount E1.

The average etching amount E2 per unit area in the central region inward of the end regions is measured by the following procedure. First, in the central region (a 20 cm wide region within 10 cm from a center) inward of the two end regions, samples (0.5 cm wide and 10 cm long) are cut out at a plurality of points (six or more, for example, six points) at approximately equal intervals. Then, the etching amount per unit area of each sample is obtained using the method described above. Then, the average etching amount E2 is obtained by arithmetically averaging the obtained etching amounts per unit area.

Conventionally, an aluminum etching foil for an electrolytic capacitor has been manufactured by AC etching or the like. In AC etching, an AC voltage is applied between two opposing electrode plates that sandwich an aluminum raw foil, to allow an AC current to flow between the two electrode plates. Electrolytic etching is performed by passing the AC current through the aluminum raw foil. As a general rule, in the central region of the aluminum raw foil, the current flows without avoiding the aluminum raw foil, and therefore a current close to the theoretical value passes through the aluminum raw foil.

On the other hand, at the two ends of the aluminum raw foil, a part of the AC current bypasses the ends of the aluminum raw foil and flows between the electrode plates without passing through the aluminum raw foil. Therefore, at the two ends of the aluminum raw foil, the current for etching is smaller than the current passing through the center of the raw foil. Therefore, in a conventional aluminum etching foil, the above-mentioned etching amount E1 in the end regions may be significantly reduced. In the conventional aluminum etching foil, since the etched layer is thin, a significant reduction in E1 may not be a problem. However, as a demand for higher capacity increases and the etched layer becomes thicker, variation in the etching amount has become a significant problem. In the foil (F) (the foil (F1) and the foil (F2)) according to the present embodiment, variation in the etching amount of the foil is reduced. Therefore, even when the etched layer is thickened, the foil can be preferably used in the electrolytic capacitor.

The etching amount of the aluminum etching foil can be measured by a method described in the examples. The etching amount can be changed by changing the time and conditions of etching treatment. The ratio E1/E2 can be changed by changing the shape of the electrodes, the shape of current shielding plates the etching conditions, or the like during etching. Conventionally, no attention has been paid to the two ends of the etching foil, but the inventors of the present application have newly found that it is possible to suppress bending and wrinkles even near the two ends by controlling the etching amount at the two ends.

The ratio E1/E2 is preferably 0.97 or more, 0.98 or more, or 0.99 or more, and may be 1.20 or less, 1.10 or less, or 1.06 or less. The ratio E1/E2 may be 0.94 or more and 1.10 or less (for example, 0.97 or more and 1.06 or less). By setting the ratio E1/E2 in this range, a particularly high effect can be obtained.

In the foil (F1), when Emax (mg/cm²) and Emin (mg/cm²) are respectively maximum and minimum values of the etching amount (per unit area) in the two end regions and the etching amount (per unit area) in the central region, (Emax−Emin)≤5.1 may be satisfied. According to this configuration, a particularly high effect can be obtained. The value of (Emax−Emin) is preferably 1.0 or less, and more preferably 0.95 or less. The value of (Emax−Emin) is 0 or more. The value of (Emax−Emin) is preferably small, but it is difficult to reduce it to completely zero, and in actual production it may be 0.1 or more (for example, 0.2 or more).

### (Second Aluminum Etching Foil)

The second aluminum etching foil (foil (F2)) has a width W in the range of 460 to 520 mm and a length L of 100 m or more. The foil (F2) includes a core portion and two porous portions continuous with the core portion and constituting the first and second main surfaces. When T1 (μm) is a sum of thicknesses of the two porous portions at a position 2 mm away from one end in the width direction at a desired position, and T2 (μm) is a sum of the thicknesses of the two porous portions at a central position in the width direction at the desired position, 0.1≤T1/T2 is satisfied.

In the foil (F2), the thickness T1 of the porous portions near the ends in the width direction and the thickness T2 of the porous portions at the central position satisfy 0.1≤T1/T2. Therefore, bending and wrinkles at the two ends of the foil (F2) can be suppressed. Furthermore, when the foil (F2) is processed to prepare the electrode foil for an electrolytic capacitor, cracking of the foil and the etched layer can be suppressed. Therefore, by using the foil (F2), it is possible to stably manufacture a high-capacity electrolytic capacitor at low cost.

The thicknesses T1 and T2 are measured at a position in the width direction at the selected desired position of the foil (F2). The thicknesses T1 and T2 were directly measured with a scanning electron microscope (SEM) at a cross-section of the aluminum etching foil after exposing the cross-section. A method for exposing the cross-section may be a method in which the foil is embedded in resin and then polished. Alternatively, the cross-section may be exposed by ion milling or the like. The value of T1/T2 can be changed by changing the shape of the electrodes, the shape of current shielding plates, the arrangement in which the foil, the electrode, and the shielding plates are arranged, the etching conditions (temperature, current, and the like), or the like during etching.

T1/T2 is preferably 0.70 or more or 0.85 or more, and preferably 1.3 or less or 1.15 or less. By making T1/T2 1.15 or less, it is possible to suppress foil breakage, cracking, and bending caused by excessive melting near the ends and reduced end strength.

When Tz (μm) is the sum of the thicknesses of the two porous portions at a position Z mm away from one end in the width direction, and T2 (μm) is the sum of the thicknesses of the two porous portions at the central position in the width direction at the desired position, 0.1≤Tz/T2 may be satisfied. The value of Tz/T2 may be in the range exemplified for T1/T2. Here, Z is preferably 1 (mm), and more preferably 0.5 (mm).

In the foil (F2), the thickness of the foil (F2) may be 90 μm or more and 220 μm or less, and the thickness T2 may be 50 μm or more. By setting the thickness of the foil (F2) and the value of T2 within the above ranges, a particularly high effect can be obtained. When the thickness of the foil (F2) is 90 μm or more and 220 μm or less, the thickness T2 may be 50 μm or more or 60 μm or more, and may be 190 μm or less or 170 m or less. In addition, the thickness T1 is preferably 60 μm or more. When the thickness of the foil (F2) exceeds 120 μm, the thickness T1 is preferably 80 μm or more, 115 μm or more, or 128 μm or more, and may be 180 μm or less or 170 μm or less.

(Matters common to foil (F1) and foil (F2)) The foil (F) is described below. In other words, matters common to the foil (F1) and the foil (F2) are described below. Note that an example of the foil (F1) may satisfy requirements required for the foil (F2). An example of the foil (F2) may satisfy requirements required for the foil (F1).

In the foil (F), the two porous portions are arranged to sandwich the core portion. One porous portion is present on one side of the foil, and the other porous portion is present on the other side of the foil.

The width W of the foil (F) is generally constant throughout the foil. The width W of the foil (F) is 460 mm or more, and preferably 480 mm or more, or 490 mm or more. The closer the width of the foil is to 500 mm, the easier it is to set the foil on the chemical conversion equipment in a subsequent chemical conversion step. Further, if the width of the foil is narrow, the number of slit foils decreases when slitting is performed during a capacitor manufacturing process, resulting in poor yield.

The width W is 520 mm or less, and preferably 515 mm or less (for example, 510 mm or less). When the foil is too wide, it is difficult to set the foil on an existing chemical conversion equipment, and even when the foil can be set, the ends come into contact with the chemical conversion equipment, resulting in a higher probability of foil cracking, scratching, bending, and the like.

The width W is preferably in a range of 480 to 515 mm, or 490 to 510 mm. By setting the width in these ranges, it is easier to directly use equipment currently available on the market and used for storing and processing (chemically converting) the aluminum etching foil.

The thickness of the foil (F) may be 70 μm or more, or 90 μm or more, and is preferably 100 μm or more. The foil (F) has a particularly high effect when used as a foil for a high-capacity electrolytic capacitor (a high-capacity foil). By setting the thickness of the foil (F) to a certain value or more, a foil suitable for a high-capacity electrolytic capacitor can be obtained.

Further, the thickness of the foil (F) may be 250 μm or less, 200 μm or less, or 150 μm or less. By setting the thickness of the foil (F) to a certain value or less, foil transportation and the like are easy.

The thickness of the foil (F) is preferably in a range of 90 to 200 μm (for example, in a range of 100 to 190 μm). This is because within this range, it is possible to produce a high-capacity electrode foil using an etching technique, and there are fewer issues related to equipment for foil transportation and the like.

The length L of the foil (F) is 100 μm or more, and preferably 200 μm or more, or 300 μm or more. When producing the same amount of foil, and the length L is shorter, the number of foils increases, and a larger area is required for storage. Further, when producing the same amount of foil, and the length L is shorter, there is an increase in the number of times the foil is set on the chemical conversion equipment and the number of times the foil is set in a capacitor manufacturing step, resulting in more man-hours.

The length L of the foil (F) may be 2000 μm or less, or 1000 μm or less. When the foil (F) is too long, it is difficult to set the foil on the chemical conversion equipment, or the foil is too heavy and the setting of the foil on the equipment, and movement, conveyance, and transportation of the foil is difficult. The foil (F) is preferably wound into a roll.

The foil (F) may be a foil having two ends not cut in the width direction after the porous portion is formed by the etching treatment. In this case, end surfaces of the foil in the width direction are made porous by etching.

The foil (F) may be a foil having two ends cut in the width direction after the porous portion is formed by the etching treatment. This configuration makes it easier to make the porous portion uniform across the width direction.

In the foil (F), the porous portion may include an inner layer region on the core portion side and a surface layer region on the opposite side to the core portion. In this case, when the thickness of the porous portion is T (μm), the surface layer region is a region extending to a distance of T/4 or less from the outer surface of the porous portion, and the inner layer region is a region extending to a distance of T/4 or less from the boundary between the porous portion and the core portion. Also, an average diameter D₁ (nm) of pores in the surface layer region may be smaller than an average diameter D₂ (nm) of pores in the inner layer region. This configuration enables production of an electrode foil with higher capacity and strength. By making the average diameter D₁ (nm) smaller than the average diameter D₂ (nm), the tensile strength of the foil (F) can be increased. As a result, foil breakage caused by foil bending and foil breakage in the capacitor manufacturing step can be reduced.

The average diameters D₁ and D₂ can be obtained as follows.
(i) A sectional image of the electrode foil is obtained using a scanning electron microscope (SEM). Using the image, the thickness of the porous portion is measured at 10 arbitrary points, and the average value of the thicknesses is calculated to be the thickness T of the one porous portion.
(ii) A region of the porous portion extending to a distance of T/4 or less from the outer surface (surface S in FIG. 3) is defined as the surface layer region.
(iii) A sectional image of the surface layer region is obtained, and the image is subjected to binarization processing to distinguish a metal skeleton region constituting the surface layer region from a pore (pit) region other than the metal skeleton region.
(iv) A point is arbitrarily selected in the pore region of the surface layer region, a line segment passing through the point and crossing the pore region is drawn, and the length of the line segment when the length of the line segment is shortest is measured. This measurement is performed for 20 arbitrary points in the pore region of the surface layer region, and the average value of the obtained measurement values is defined as the average diameter D₁ of the pores in the surface layer region.
(v) A region of the porous portion extending to a distance of T/4 or less from the boundary (boundary B in FIG. 3) between the porous portion and the core portion is defined as the inner layer region. The average diameter D₂ of the pores in the inner layer region is also determined in the same manner as the above (iii) and (iv).

From the viewpoint of increasing capacitance, the ratio D₁/D₂ of the average diameter D₁ to the average diameter D₂ may be 0.5 or more, 0.55 or more, 0.6 or more, or 0.7 or more. From the viewpoint of suppressing a decrease in strength of a surface layer and increasing capacity per unit volume, D₁/D₂ may be 0.98 or less, 0.95 or less, or 0.9 or less. The range of D₁/D₂ may be any combination of the above upper and lower limits, but from the viewpoint of suppressing a decrease in strength of the surface layer and increasing the capacity per unit volume, the range is preferably 0.5 or more and 0.98 or less, and more preferably 0.55 or more and 0.95 or less.

The ratio D₁/D₂ of D₁ to D₂ may be 0.5 or more and 0.98 or less (for example, 0.6 or more and 0.92 or less). This configuration enables the production of the electrode foil with higher capacity and strength. By setting the ratio D₁/D₂ in the above range, the tensile strength of the foil (F) can be increased. As a result, foil breakage caused by foil bending and foil breakage in the capacitor manufacturing step can be suppressed. Furthermore, by suppressing a decrease in pore diameter in the inner layer region, it is possible to increase the capacity, especially on the high voltage side. In addition, it is easier to impregnate the inner layer region with an electrolyte or a polymer, and an effect of reducing the ESR of the capacitor is also obtained.

From the viewpoint of suppressing a decrease in the strength of the surface layer and improving retention of electrolyte in the pores, a porosity P₁ of the surface layer region may be smaller than a porosity P₂ of the inner layer region. From the viewpoint of increasing the capacitance, the ratio P₁/P₂ of P₁ to P₂ may be 0.5 or more, 0.55 or more, 0.6 or more, or 0.7 or more. From the viewpoint of suppressing a decrease in the strength of the surface layer and increasing the capacity per unit volume, the ratio P₁/P₂ may be 0.95 or less, 0.92 or less, or 0.85 or less. The ratio P₁/P₂ may be within a range that combines any of the above upper and lower limits. The ratio P₁/P₂ may be 0.5 or more and 0.95 or less, or 0.55 or more and 0.92 or less.

The porosity P₁ of the surface layer region can be determined by using the sectional image of the surface layer region after the binarization processing of the above (iii), obtained in the process of determining D₁. Specifically, an area S₀ of the entire region of the image and an area S₁ of the region occupied by the pores in the image are measured, and the porosity P₁ can be determined by calculating (S₁/S₀)×100. The porosity P₂ of the inner layer region can also be determined in the same manner as above.

A surface roughness Ra of the foil (F) is preferably 2.0 μm or less, more preferably 1.5 μm or less, and still more preferably 0.8 μm or less. Here, the surface roughness Ra refers to the surface roughness of the outer surface of the porous portion. The surface roughness Ra of the electrode foil means an arithmetic mean roughness Ra determined in accordance with Japanese Industrial Standards (JIS) B 0601:2001. By setting the surface roughness Ra of the electrode foil to 2.0 μm or less (for example, 1.5 m or less), it is possible to suppress a decrease in strength and capacity due to the surface roughness.

For the foil (F), in a pore distribution of the porous portion measured by mercury intrusion porosimetry, a cumulative pore volume V₀ (cm³/g) in a pore diameter range of 0.01 μm or more and 1 μm or less and a cumulative pore volume V_{S1} (cm³/g) in a pore diameter range of 0.01 μm or more and 0.06 μm or less may satisfy a relationship of V_{S1}/V₀≤0.07.

It is preferable that the foil (F) further satisfies a relationship of V_{S2}/V₀≤0.05 (or 0.04) in the pore distribution of the porous portion measured by the mercury intrusion porosimetry. As described above, V₀ is the cumulative pore volume (cm³/g) in the pore diameter range of 0.01 μm or more and 1 μm or less. V_{S2} is the cumulative pore volume (cm³/g) in the pore diameter range of 0.01 μm or more and 0.05 μm or less. The pore distribution is measured by mercury intrusion porosimetry, for example, using AutoPore V series manufactured by Micromeritics Instrument Corporation.

Small pores with a pore diameter of 0.01 μm or more and 0.06 μm or less (or 0.05 m or less) are easily blocked by a dielectric layer, which is disadvantageous in terms of increasing the capacity, reducing the ESR, and the strength. In the porous portion, the portion where the pores are blocked by the dielectric layer not only does not contribute to increasing the capacity, but also becomes hard and brittle. When the number of small pores increases and the number of blocked portions increases, the strength of the electrode foil decreases, and the electrode foil cracks or the foil breaks in the manufacturing process of the electrolytic capacitor (transporting the electrode foil, slitting, winding, connection to a lead member by crimping, and the like). In contrast, when V_{S1}/V₀ (and further V_{S2}/V₀) is within the above range, there are few small pores and many pores with pore diameters suitable for increasing the capacity are distributed, making it possible to increase the capacity. In addition, in this case, there are few blocked portions, and a decrease in the strength can be suppressed. By using such a foil, it is possible to manufacture a large-capacity electrolytic capacitor having excellent reliability.

In the foil (F), in the pore distribution of the porous portion measured by the mercury intrusion porosimetry, it is preferable that the cumulative pore volume V₀ (cm³/g), and a cumulative pore volume V_{L1} (cm³/g) in a pore diameter range of 0.16 μm or more and 1 μm or less satisfy a relationship of V_{L}/V₀≤0.4. In the foil (F), in the pore distribution of the porous portion measured by the mercury intrusion porosimetry, it is preferable that a relationship of V_{L2}/V₀≤0.1 (or 0.08) is further satisfied. V_{L2} is a cumulative pore volume (cm³/g) in a pore diameter range of 0.5 μm or more and 1 μm or less.

Large pores with a pore diameter of 0.16 μm or more (or 0.5 μm or more) and 1 m or less are unlikely to contribute to increasing the capacity. The large pores are disadvantageous in terms of a desire to increase the surface area of the electrode foil. For example, in the case of large pores, when two pores are formed at close positions, they tend to crush each other, and the perimeter of the pores (the total length of outlines of inner wall surfaces of the pores present per unit area of a cross section of the porous portion) tends to be small, making it difficult to contribute to increasing the capacity. When V_{L1}/V₀ (and further V_{L}/V₀) is within the above range, there are few large pores. Therefore, many pores with the pore diameters suitable for increasing the capacity are distributed, making it easy to increase the surface area of the electrode foil and increase the capacity.

Distribution of the pore diameters can be changed, for example, by changing the etching conditions. Specifically, the proportion of small pores can be increased by increasing the current density during etching.

The foil (F) may be cut and used as the electrode foil after an oxide film is formed on a surface of the foil by the chemical conversion treatment. Examples of a method for evaluating the oxide film formed include evaluation based on a CV value which is the product of capacitance C and breakdown voltage V. As variation in the CV value is smaller, an electrolytic capacitor having a smaller variation in performance can be manufactured. In the foil (F), since bias in the thickness (etching amount) of the porous portion is small, variation in the CV value after formation of the oxide film can be reduced. When the CV value is measured by a method described in the example to be described below, the standard deviation a of the CV value is preferably 0.7 or less.

### (Method for Manufacturing Aluminum Etching Foil)

An example of a method for manufacturing the above-mentioned aluminum etching foil (foil (F)) is described below. This manufacturing method may be referred to as “manufacturing method (M)” below. According to the manufacturing method (M), it is possible to manufacture both the foil (F1) and the foil (F2). Since matters described regarding the foil (F1) and the foil (F2) can be applied to the manufacturing method (M) below, redundant descriptions will be omitted. Matters described regarding the manufacturing method (M) may be applied to the foil (F1) and the foil (F2). Note that the foil (F1) and the foil (F2) may be manufactured by a method other than the manufacturing method (M).

### (Etching Step)

The manufacturing method (M) includes an etching step of etching an aluminum sheet (hereinafter may be referred to as “first sheet”) to form the porous portions on both sides of the sheet. The etching step roughens surfaces of the sheet, to form a second sheet having the above-mentioned core portion and two porous portions.

The thickness and size of the first sheet are selected according to the thickness and size required for the foil (F) (the foil (F1) or the foil (F2)). The thickness of the first sheet may be within the range exemplified for the thickness of the foil (F). Note that when pressing is performed after the etching step, the thickness of the first sheet is selected taking into account the amount of thickness reduction caused by pressing.

When a sheet obtained by processing the first sheet is used as the foil (F) without cutting, the size (width and length) of the first sheet may be in the range of the size (width W and length L) exemplified as the size of the foil (F). When the sheet obtained by processing the first sheet is cut in a cutting step (described later) and used as a cut foil (F), the size (width and length) of the first sheet is larger than the size (width W and length L) exemplified as the size of the foil (F1) and the foil (F2). For example, when the cutting step is performed to cut the two ends in the width direction, the width of the first sheet is larger than the width W exemplified for the foil (F). When the sum of widths of the two ends to be cut is Wcut (mm), the width of the first sheet is larger than the width W exemplified for the foil (F) by Wcut. The width of the first sheet may be in a range of 490 to 540 mm (for example, in a range of 500 to 530 mm).

In the manufacturing method (M), the etching is preferably electrolytic etching. By performing the electrolytic etching under specified conditions, it is easier to manufacture the above-mentioned foil (F).

From the viewpoint of forming pores with a large diameter, the electrolytic etching may be performed at a current density of 2.0 A/cm² or less, 1.5 A/cm² or less, or 1.2 A/cm² or less. The current density may be changed during etching. A larger pore diameter makes it easier to form a thicker dielectric layer, and is advantageous in terms of increasing voltage.

The electrolytic etching is preferably AC etching, but may also be DC etching. In the case of the AC etching, it is easy to form a porous portion containing sponge-like pits with a relatively small diameter. In the case of the DC etching, it is easy to form a porous portion including tunnel-like pits with relatively large diameters.

When T_{E} is the etching time of the electrolytic etching, the temperature of etching solution may be set to 10° C. or more and 60° C. or less between 0 and 0.7T_{E}, and may be set to 5° C. or more and 40° C. or less between 0.7T_{E} and T_{E}. In this case, variation in pit diameter in the thickness direction of the porous portion can be reduced. The etching time T_{E} is, for example, 15 minutes or more and 60 minutes or less.

The etching solution for the electrolytic etching is not particularly limited, and a known etching solution may be used. As the etching solution for the electrolytic etching, hydrochloric acid, nitric acid, sulfuric acid, or phosphoric acid may be used, and these acids may be mixed. Hydrochloric acid concentration of the etching solution is preferably in a range of 0.2 to 1.5 N.

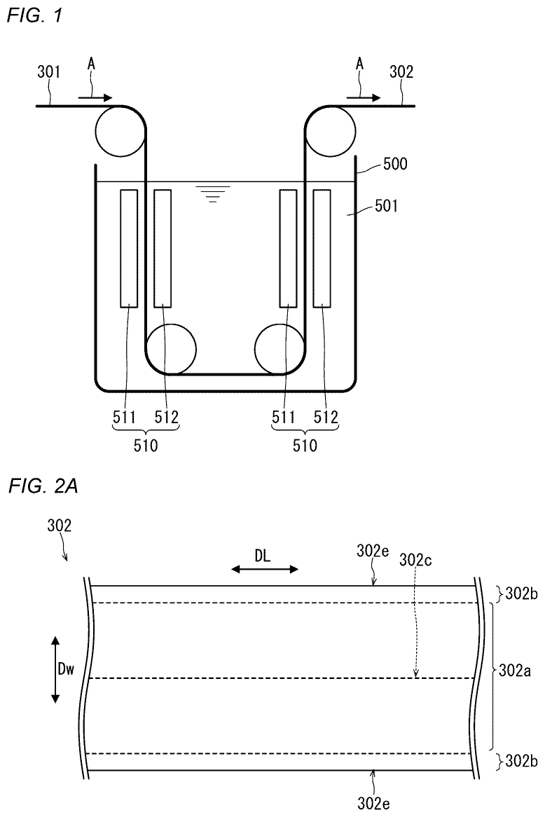

An example of an AC etching method is schematically illustrated in FIG. 1. As illustrated in FIG. 1, a first sheet 301 is conveyed in the direction of an arrow A so as to go through an etching solution 501 placed in a treatment tank 500. In the treatment tank 500, an electrode pair 510 (a first electrode 511 and a second electrode 512) is arranged to sandwich the conveyed first sheet 301. The first sheet 301 is etched by applying the AC voltage between the first electrode 511 and the second electrode 512. Thus, a second sheet 302 is produced in which the above-mentioned core portion and porous portions are formed.

FIG. 1 illustrates an example using two electrode pairs 510. However, the number of electrode pairs is not particularly limited and may be one, or two or more. The widths of the first electrode 511 and the second electrode 512 are each approximately the same as the width of the first sheet 301.

When the etching is performed using a typical method, the etching amount of the first sheet 301 varies greatly depending on the position in the width direction of the sheet. For example, at the two ends in the width direction, since part of the current flowing when the voltage is applied passes around the sheet, the etching amount is reduced. As a result, the porous portion is thinner at the two ends in the width direction. Therefore, when performing the electrolytic etching, shielding plates made of an insulating material are placed near the two ends of the first sheet 301 in the width direction. By providing the shielding plates, the foil (F) having the above-mentioned configuration can be formed. That is, in this case, the second sheet 302 obtained by the etching step can be used as the foil (F).

The shielding plates may be flat. Alternatively, the shielding plates may be shaped to surround the ends of the first sheet 301. For example, the sectional shape of the shielding plates may be U-shaped to surround the ends of the first sheet 301.

FIG. 2A is a top view schematically illustrating an example of the second sheet 302. The example of the second sheet 302 illustrated in FIG. 2A has two strip-shaped regions 302b at the two ends in the width direction Dw. The regions 302b extend along two ends (both ends) 302e of the second sheet 302 in the width direction Dw. Note that FIG. 2A also illustrates a line 302c located in the longitudinal direction DL of the second sheet 302 and at the center in the width direction Dw. A region 302a (central region) exists between the two regions 302b. When the above-mentioned shielding plate or the like is not used, the regions 302b are regions in which the average thickness of the porous portion is smaller than the average thickness of the porous portion of the region 302a. In other words, when the shielding plates or the like is not used, the etching amount in the region 302b is smaller than the etching amount in the region 302a. Unevenness of the etching amount can be reduced by using the above-mentioned shielding plates or the like. As described above, the ratio E1/E2 is 0.90 or more and 1.30 or less. That is, the etching amount in the region 302b may be greater than or equal to the etching amount in the region 302a.

After the etching step is performed, a pressing step and/or the cutting step may be performed. In the pressing step, the second sheet 302 is pressed. In the cutting step, the two ends of the second sheet 302 (at least a part of the region 302b) are cut. By cutting at least a part of the region 302b, the unevenness of the etching amount (unevenness of the thickness of the porous portion) can be reduced.

The width by which the second sheet 302 is cut when performing the cutting step is selected depending on the width of the region 302b and degree of the unevenness of the thickness of the porous portion. However, when the region to be cut is too large, there will be a lot of loss. Therefore, even when performing the cutting step, it is preferable to reduce the unevenness of the etching amount in the etching step to reduce the region to be cut. The width by which the second sheet 302 is cut when performing the cutting step may be in a range of 5 to 40 mm (for example, in a range of 5 to 20 mm) at each end.

As described above, the foil (F) (the foil (F1) and the foil (F2)) is manufactured. The manufactured foil (F) is usually distributed in a rolled state. FIG. 2B is a top view schematically illustrating an example of a finally obtained foil (F). An aluminum etching foil 300 that is an example illustrated in FIG. 2B has two end regions 300b extending along two ends (both ends) 300e in the width direction Dw, and a central region 300a inward of the end regions 300b. The central region 300a is a region sandwiched between the two end regions 300b. Note that FIG. 2B also illustrates a line 300c located in the longitudinal direction DL of the aluminum etching foil 300 and at the center of the width direction Dw.

FIG. 3 is a sectional view schematically illustrating an example of the aluminum etching foil (foil (F)) according to the present disclosure. FIG. 3 illustrates a cross-section in a thickness direction of the aluminum etching foil.

The aluminum etching foil 300 includes a core portion 330 and porous portions 310 and 320 continuous with the core portion 330. The porous portions 310 and 320 are formed to sandwich the core portion 330.

One porous portion 310 has a thickness T (μm). The porous portion 310 has an inner layer region 312 on the core portion 330 side, and a surface layer region 311 on the opposite side to the core portion 330. The surface layer region 311 is a region extending to a distance of T/4 or less from an outer surface S of the porous portion 310. The inner layer region 312 is a region extending to a distance of T/4 or less from the boundary B between the porous portion 310 and the core portion 330. The other porous portion 320 also has a surface layer region 321 and an inner layer region 322 similarly to the porous portion 310.

### (Additional Note)

The above description discloses the following technology.

### (Technology 1)

An aluminum etching foil for an electrolytic capacitor, having
a width in a range of 460 to 520 mm, and
a length of 100 μm or more,
the aluminum etching foil comprising a core portion, and two porous portions continuous with the core portion and constituting first and second main surfaces,
wherein the porous portions are porous portions formed by etching, and
when E1 (mg/cm²) is a smaller of etching amounts per unit area in two end regions extending to a distance in a range of 2 to 7 mm away from two ends in a width direction at a desired position, and E2 (mg/cm²) is an average etching amount per unit area in a central region inward of the two end regions, a ratio E1/E2 is 0.90 or more and 1.30 or less.

### (Technology 2)

The aluminum etching foil according to Technology 1, wherein the ratio E1/E2 is 0.94 or more and 1.10 or less.

### (Technology 3)

The aluminum etching foil according to Technology 1 or 2, wherein when Emax (mg/cm²) and Emin (mg/cm²) are respectively a maximum value and a minimum value of the etching amounts per unit area in the two end regions and the etching amounts per unit area in the central region, (Emax−Emin)≤5.1 is satisfied.

### (Technology 4)

An aluminum etching foil for an electrolytic capacitor, having
a width in a range of 460 to 520 mm, and
a length of 100 μm or more,
the aluminum etching foil comprising a core portion, and two porous portions continuous to the core portion and constituting first and second main surfaces,
wherein when T1 (μm) is a sum of thicknesses of the two porous portions at a position 2 mm away from one end in a width direction at a desired position, and T2 (μm) is a sum of thicknesses of the two porous portions at a central position in the width direction at the desired position, 0.1≤T1/T2 is satisfied.

### (Technology 5)

The aluminum etching foil according to Technology 4,
wherein a thickness of the aluminum etching foil is 90 μm or more and 200 μm or less, and
T2 is 50 μm or more.

### (Technology 6)

The aluminum etching foil according to any one of Technologies 1 to 5, wherein an end surface in the width direction has been made porous by etching.

### (Technology 7)

The aluminum etching foil according to any one of Technologies 1 to 6,
wherein each of the porous portions includes an inner layer region on a core portion side and a surface layer region on an opposite side to the core portion,
when T (μm) is a thickness of the porous portions, the surface layer region is a region extending to a distance of T/4 or less from an outer surface of the porous portions, and the inner layer region is a region extending to a distance of T/4 or less from a boundary between the porous portions and the core portion, and
an average diameter D₁ (nm) of pores in the surface layer region is smaller than an average diameter D₂ (nm) of pores in the inner layer region.

### (Technology 8)

The aluminum etching foil according to Technology 7, wherein a ratio D₁/D₂ of D₁ to Dₐ is 0.5 or more and 0.98 or less.

### (Technology 9)

The aluminum etching foil according to Technology 7 or 8, wherein a porosity P₁ of the surface layer region is smaller than a porosity P₂ of the inner layer region.

### (Technology 10)

The aluminum etching foil according to Technology 9, wherein a ratio P₁/P₂ of P₁ to P₂ is 0.5 or more and 0.95 or less.

### (Technology 11)

The aluminum etching foil according to any one of Technologies 1 to 10, having a surface roughness Ra of 1.5 μm or less.

### (Technology 12)

The aluminum etching foil according to any one of Technologies 1 to 11,
wherein in a pore distribution of the porous portions measured by mercury intrusion porosimetry,
a cumulative pore volume V₀ (cm³/g) in a pore diameter range of 0.01 μm or more and 1 μm or less and a cumulative pore volume Vₛ₁ (cm³/g) in a pore diameter range of 0.01 μm or more and 0.06 μm or less satisfy a relationship of Vₛ₁/V₀≤0.07.

### (Technology 13)

The aluminum etching foil according to Technology 12,
wherein in the pore distribution of the porous portions,
the cumulative pore volume V₀ (cm³/g), and a cumulative pore volume V_{L1} (cm³/g) in a pore diameter range of 0.16 μm or more and 1 μm or less satisfy a relationship of V_{L1}/V₀≤0.4.

### Examples

Hereinafter, the present disclosure will be described in more detail based on examples, but the present disclosure is not limited to the examples. In the following examples, etching was performed under different etching conditions to prepare a plurality of aluminum etching foils. Then, the prepared aluminum etching foils were evaluated.

### (Etching Step)

A foil-like aluminum sheet (thickness: 115 μm, width W: 500 mm) was subjected to AC etching to form the porous portions on both sides of the aluminum sheet. The length of the aluminum sheet was long enough to reproduce an etching foil of 100 μm or more as a sample. A mixed acid containing hydrochloric acid as a main component was used as the etching solution. At this time, the above-mentioned shielding plates were placed near the two ends of the foil. The shielding plates were placed so that the surface direction of the shielding plates was perpendicular to the surface direction of the aluminum sheet. A distance X between ends of the electrodes (the first electrode 511 and the second electrode 512) and the shielding plate and the average current density were adjusted to values in Table 1, and the etching was performed to prepare etching foils (aluminum etching foils) A1 to A5 and C1. In addition, the etching time was finely adjusted as appropriate so that the etching amount was appropriate. The foils A1 to A5 are foils (F1), and the etching foil C1 is an etching foil of a comparative example. The etching conditions for the etching foil C1 are conventional etching conditions.

TABLE 1

| Etching | Distance X | Average current density |
|---|---|---|
| foil | (mm) | (mA/cm²) |
| C1 | 2.0 | 295 |
| A1 | 1.0 | 295 |
| A2 | 1.0 | 305 |
| A3 | 1.0 | 310 |
| A4 | 0.5 | 295 |
| A5 | 0.5 | 305 |

### (Evaluation)

The obtained etching foils were evaluated by the following methods.

### (1) Etching Amount

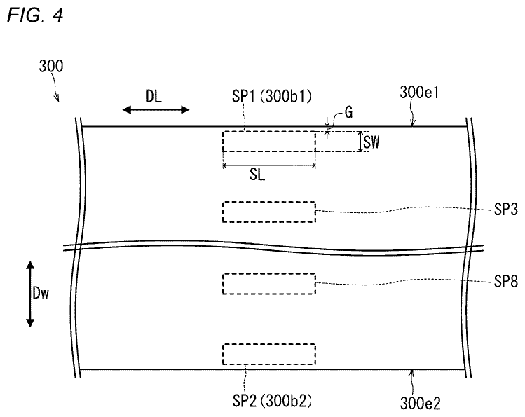

The etching amount of the etching foil was measured by the following method. First, an arbitrary point on the etching foil (aluminum etching foil 300) was selected, and samples were taken at eight positions in the width direction Dw from that point. The positions of the cut samples are schematically illustrated in FIG. 4. A sample SP1 in one end region 300b1 had a distance G of 2 mm from an end 300e1, a width SW of 5 mm in the width direction Dw, and a length SL of 100 mm in the longitudinal direction DL. Similarly, a sample SP2 in the other end region 300b2 had a distance G of 2 mm from the other end 300e2, a width SW of 5 mm, and a length SL of 100 mm. That is, the samples SP1 and SP2 were respectively cut out from a range of 2 to 7 mm away from the ends 300e1 and 300e2. Samples SP3 to SP8 (samples SP4 to SP7 are not illustrated) in the central region between the end region 300b1 and the end region 300b2 were cut out to be approximately equally spaced from each other in the region between the end region 300b1 and the end region 300b2. Similar to the samples in the end regions, the samples SP3 to SP8 also had a width SW of 5 mm and a length SL of 100 mm.

Next, a mass M1 (mg) of each sample taken was measured. In addition, a thickness H1 of one sample was measured. Then, from true density of aluminum, a mass M0 (mg) of aluminum with an area of 5 cm², a thickness of H1, and no voids was determined. Note that since the thickness of the etching foil was almost constant and there was little change in thickness before and after etching, the thickness H1 measured for one sample was regarded as the thickness H1 for all samples. Then, the etching amount per cm² for each sample was calculated using the following formula.

$$Etching amount E ( mg / {cm}^{2} ) = ( M 0 - M 1 ) / 5$$

### (2) Calculation of CV Value

The obtained etching foil was subjected to chemical conversion treatment in accordance with EIAJ standard RC2364A to form the oxide film on the surface of the etching foil. Then, for each etching foil, the capacitance C and the breakdown voltage V were measured at a plurality of measurement points. The measurement points were selected in the same manner as a method for selecting sample collection positions in the above-mentioned etching amount measurement. The capacitance and breakdown voltage were measured in accordance with EIAJ standard (RC-2364A). Then, the product (CV value) of the capacitance C and the breakdown voltage V was calculated.

Evaluation results of the etching amount are shown in Tables 2 and 3. Note that in Table 2, the etching amount E1 is the smaller of the two etching amounts (per unit area) measured in the end regions. The etching amount E2 is the average value of six etching amounts (per unit area) measured in the central region. The ratio E1/E2 is a value obtained by dividing E1 by E2. In Table 3, the standard deviation of the etching amount is the standard deviation of all the measured etching amounts. The maximum etching amount Emax (mg/cm²) is the maximum value of all the measured etching amounts. The minimum etching amount Emin (mg/cm²) is the minimum value of all the measured etching amounts. Here, all the measured etching amounts are etching amounts at the eight positions present in the width direction of one arbitrarily selected point. Two of the eight positions are in the two end regions. Six of the eight positions are positions selected to be approximately equally spaced from each other in the region between the two end regions.

TABLE 2

| | C1 | A1 | A2 | A3 | A4 | A5 |
|---|---|---|---|---|---|---|
| Etching amount E1 (mg/cm²) | 9.6 | 14.6 | 14.5 | 14.4 | 14.2 | 13.1 |
| Etching amount E2 (mg/cm²) | 13.8 | 13.8 | 13.8 | 13.8 | 13.8 | 13.8 |
| Ratio E1/E2 | 0.70 | 1.06 | 1.05 | 1.05 | 1.02 | 0.95 |

TABLE 3

| | C1 | A1 | A2 | A3 | A4 | A5 |
|---|---|---|---|---|---|---|
| Standard deviation of etching | 0.45 | 0.24 | 0.21 | 0.19 | 0.15 | 0.13 |
| amount | | | | | | |
| Maximum etching amount | 14.8 | 14.8 | 14.7 | 14.7 | 14.3 | 14.3 |
| Emax | | | | | | |
| Minimum etching amount | 9.6 | 13.7 | 13.7 | 13.7 | 13.7 | 13.7 |
| Emin | | | | | | |
| Emax − Emin | 5.2 | 1.1 | 1.0 | 1.0 | 0.6 | 0.6 |

The etching foils A1 to A5 are the foils (F) according to the present disclosure, and the etching foil C1 is an etching foil of the comparative example. As shown in Table 2, the ratio E1/E2 was 0.90 or more and 1.30 or less in the etching foils A1 to A5. As shown in Table 3, the etching foils A1 to A5 satisfied (Emax−Emin)≤5.1.

Evaluation results of the CV values are shown in Table 4. In Table 4, the maximum CV value and the minimum CV value are respectively maximum and minimum values among all the CV values measured.

TABLE 4

| | C1 | A1 | A2 | A3 | A4 | A5 |
|---|---|---|---|---|---|---|
| Standard | 3.7 | 0.62 | 0.61 | 0.61 | 0.53 | 0.49 |
| deviation of CV | | | | | | |
| value | | | | | | |
| Maximum CV | 101.7 | 102.3 | 102.2 | 102.2 | 102.1 | 102.1 |
| value (μF × V) | | | | | | |
| Minimum CV | 58.6 | 99.2 | 98.6 | 98.7 | 99.3 | 99.4 |
| value (μF × V) | | | | | | |
| Maximum CV | 43.0 | 3.1 | 3.5 | 3.6 | 2.8 | 2.7 |
| value − Minimum | | | | | | |
| CV value | | | | | | |

As shown in Table 4, in the etching foils A1 to A5, standard deviation of the CV value was able to be reduced to 0.7 or less.

The present disclosure is applicable to an aluminum etching foil for an electrolytic capacitor.

Although the present invention has been described in terms of presently preferred embodiments, such disclosure is not to be construed as limiting. Various modifications and variations will no doubt become apparent to those skilled in the art to which the present invention pertains upon reading the above disclosure. It is therefore intended that the appended claims be construed to include all modifications and variations that do not depart from the true spirit and scope of the invention.

### REFERENCE SIGNS LIST

300: aluminum etching foil, 300a: central region, 300b: end region, 300e: ends (both ends), 310, 320: porous portion, 311, 321: surface layer region, 312, 322: inner layer region, 330: core portion, 500: treatment tank, 501: etching solution, 510: electrode pair, 511: first electrode, 512: second electrode, Dw: width direction.

What is claimed is:

1. An aluminum etching foil for an electrolytic capacitor, having
a width in a range of 460 to 520 mm, and
a length of 100 μm or more,
the aluminum etching foil comprising a core portion, and two porous portions continuous with the core portion and constituting first and second main surfaces,
wherein the porous portions are porous portions formed by etching, and
when E1 (mg/cm²) is a smaller of etching amounts per unit area in two end regions extending to a distance in a range of 2 to 7 mm away from two ends in a width direction at a desired position, and E2 (mg/cm²) is an average etching amount per unit area in a central region inward of the two end regions, a ratio E1/E2 is 0.90 or more and 1.30 or less.

2. The aluminum etching foil according to claim 1, wherein the ratio E1/E2 is 0.96 or more and 1.10 or less.

3. The aluminum etching foil according to claim 1, wherein when Emax (mg/cm²) and Emin (mg/cm²) are respectively a maximum value and a minimum value of the etching amounts per unit area in the two end regions and the etching amounts per unit area in the central region, (Emax−Emin)≤5.1 is satisfied.

4. The aluminum etching foil according to claim 1, wherein an end surface in the width direction has been made porous by etching.

5. The aluminum etching foil according to claim 1,
wherein each of the porous portions includes an inner layer region on a core portion side and a surface layer region on an opposite side to the core portion,
when T (μm) is a thickness of the porous portions, the surface layer region is a region extending to a distance of T/4 or less from an outer surface of the porous portions, and the inner layer region is a region extending to a distance of T/4 or less from a boundary between the porous portions and the core portion, and
an average diameter D₁ (nm) of pores in the surface layer region is smaller than an average diameter D₂ (nm) of pores in the inner layer region.

6. The aluminum etching foil according to claim 5, wherein a ratio D₁/D₂ of D₁ to D₂ is 0.5 or more and 0.98 or less.

7. The aluminum etching foil according to claim 5, wherein a porosity P₁ of the surface layer region is smaller than a porosity P₂ of the inner layer region.

8. The aluminum etching foil according to claim 7, wherein a ratio P₁/P₂ of P₁ to P₂ is 0.5 or more and 0.95 or less.

9. The aluminum etching foil according to claim 5, having a surface roughness Ra of 1.5 μm or less.

10. The aluminum etching foil according to claim 1,
wherein in a pore distribution of the porous portions measured by mercury intrusion porosimetry,
a cumulative pore volume V₀ (cm³/g) in a pore diameter range of 0.01 μm or more and 1 μm or less and a cumulative pore volume Vₛ₁ (cm³/g) in a pore diameter range of 0.01 μm or more and 0.06 μm or less satisfy a relationship of Vₛ₁/V₀≤0.07.

11. The aluminum etching foil according to claim 10,
wherein in the pore distribution of the porous portions,
the cumulative pore volume V₀ (cm³/g), and a cumulative pore volume V_{L1} (cm³/g) in a pore diameter range of 0.16 μm or more and 1 μm or less satisfy a relationship of V_{L1}/V₀≤0.4.

12. An aluminum etching foil for an electrolytic capacitor, having
a width in a range of 460 to 520 mm, and
a length of 100 μm or more,
the aluminum etching foil comprising a core portion, and two porous portions continuous to the core portion and constituting first and second main surfaces,
wherein when T1 (μm) is a sum of thicknesses of the two porous portions at a position 2 mm away from one end in a width direction at a desired position, and T2 (μm) is a sum of thicknesses of the two porous portions at a central position in the width direction at the desired position, 0.1≤T1/T2 is satisfied.

13. The aluminum etching foil according to claim 12,
wherein a thickness of the aluminum etching foil is 90 μm or more and 200 μm or less, and
T2 is 50 μm or more.

14. The aluminum etching foil according to claim 12, wherein an end surface in the width direction has been made porous by etching.

15. The aluminum etching foil according to claim 12,
wherein each of the porous portions includes an inner layer region on a core portion side and a surface layer region on an opposite side to the core portion,
when T (μm) is a thickness of the porous portions, the surface layer region is a region extending to a distance of T/4 or less from an outer surface of the porous portions, and the inner layer region is a region extending to a distance of T/4 or less from a boundary between the porous portions and the core portion, and
an average diameter D₁ (nm) of pores in the surface layer region is smaller than an average diameter D₂ (nm) of pores in the inner layer region.

16. The aluminum etching foil according to claim 15, wherein a ratio D₁/D₂ of D₁ to D₂ is 0.5 or more and 0.98 or less.

17. The aluminum etching foil according to claim 15, wherein a porosity P₁ of the surface layer region is smaller than a porosity P₂ of the inner layer region.

18. The aluminum etching foil according to claim 17, wherein a ratio P₁/P₂ of P₁ to P₂ is 0.5 or more and 0.95 or less.

19. The aluminum etching foil according to claim 15, having a surface roughness Ra of 1.5 μm or less.

20. The aluminum etching foil according to claim 12,
wherein in a pore distribution of the porous portions measured by mercury intrusion porosimetry,
a cumulative pore volume V₀ (cm³/g) in a pore diameter range of 0.01 μm or more and 1 μm or less and a cumulative pore volume Vₛ₁ (cm³/g) in a pore diameter range of 0.01 μm or more and 0.06 μm or less satisfy a relationship of Vₛ₁/V₀≤0.07.
